(19) United States
(12) Patent Application Publication
(10) Pub. No.: US 2010/0026710 A1
(43) Pub. Date: Feb. 4, 2010

(54) Integration of External Input Into an Application

(75) Inventors: Piranavan Selvanandan, Toronto (CA); Matthew P. Tippett, Toronto (CA); Surit Roy, Toronto (CA)

Correspondence Address: STERNE, KESSLER, GOLDSTEIN & FOX P.L.L.C., 1100 NEW YORK AVENUE, N.W., WASHINGTON, DC, 20005, US

(73) Assignee: ATI Technologies ULC, Markham (CA)

(21) Appl. No.: 12/236,189

(22) Filed: Sep. 23, 2008

Related U.S. Application Data
(60) Provisional application No. 61/084,500, filed on Jul. 29, 2008.

(51) Int. Cl. G09G 5/00

(52) U.S. Cl. 345/619; 715/764; 345/156

(57) ABSTRACT

Provided are systems, methods, and computer program products for integrating external input into an application, with little or no modification to the application. Such a system includes a graphics processing unit (GPU) and an interface module. The GPU is configured to execute graphics processing tasks for the application. The interface module is configured to (i) receive a camera view of the application and an input from an after-market device and (ii) generate an adjusted camera view based on the camera view of the application and the input from the after-market device. The adjusted camera view is then provided to a display device.

### CROSS REFERENCE TO RELATED APPLICATIONS

This application claims benefit under 35 U.S.C. §119(e) to U.S. Provisional Patent Application 61/084,500, entitled “Integration of External Input into an Application,” to Selvanandan et al., filed on Jul. 29, 2008, the entirety of which is hereby incorporated by reference as if fully set forth herein.

### BACKGROUND OF THE INVENTION

1. Field of the Invention

The present invention is generally directed to computing devices, and more particularly directed to computing devices that process graphics and/or video data.

2. Background Art

A graphics processing unit (GPU) is an application-specific integrated circuit (ASIC) that is specially designed to perform graphics processing tasks. A GPU may, for example, execute graphics processing tasks required by an end-user application—such as, for example, a video game, a web browser, a computer-aided design (CAD) application, a computer-aided manufacturing (CAM) application, or some other application that requires the execution of graphics processing tasks.

There are several layers of software between the end-user application and the GPU. The end-user application communicates with an application programming interface (API). An API allows the end-user application to output graphics data and commands in a standardized format, rather than in a format that is dependent on the GPU. Several types of APIs are commercially available—including, for example, DirectX® developed by Microsoft Corp. of Mountain View, Calif. and OpenGL® developed by Silicon Graphics, Inc. of Sunnyvale, Calif. The API communicates with a driver. The driver translates standard code received from the API into a native format of instructions understood by the GPU. The driver is typically written by the manufacturer of the GPU. The GPU then executes the instructions from the driver.

In some examples, a camera view of the end-user application may be controllable by an external device—such as, for example, a joy stick, a mouse, and/or a keyboard. In this way, a user can use the external device to change the camera view of the end-user application. For example, if the end-user application is a video game, the camera view may be controlled by a joy stick and button(s). As another example, if the end-user application is a web browser, the camera view may be controlled by a mouse and/or a keyboard. Thus, the external device enables the user to have an interactive experience with the camera view of the end-user application.

Although conventional external devices may control the camera view of an end-user application, such conventional external devices may not be commensurate with the natural movements of a user. For example, while playing a video game, a user may be naturally inclined to move his/her head or entire body to avoid an on-screen obstacle, even though a conventional external device may not be configured to receive input regarding this type of user movement.

Fortunately, after-market devices may be developed to receive such input from a user, and thereby provide the user with a more immersive and interactive experience. For example, Johnny Chung Lee converted the Wii Remote (provided by Nintendo of America Inc. in Redmond, Wash.) into a head-tracking device. In particular, Mr. Lee developed a special end-user application in which the camera view of the special end-user application is adjusted based on the relative movement of the Wii sensor bar with respect to the Wii remote. Consequently, if the Wii sensor bar is co-located with a user's head, the camera view of the special end-user application is adjusted based on the movement of the user's head. This special end-user application is illustrated in a posting by Mr. Lee on the YOUTUBE website (which is owned by Google, Inc. of Mountain View, Calif.). Similarly, another posting by Nigel Tzeng on the YOUTUBE website illustrates a modified NASA WORLD WINDS application that was designed to receive head-tracking input from the Wii Remote. Because these applications were specially designed to receive input from an after-market device (e.g., the head-tracking capabilities of the Wii Remote), the camera view of these applications is adjusted based on the movement of a user's head, thereby providing the user with a more immersive and interactive experience.

Unfortunately, most end-user applications are not designed to be controlled by such after-market devices. As a result, most users cannot enjoy the potential benefit that such after-market devices have to offer.

One potential solution to this problem is to modify and re-release end-user applications to explicitly support input from such after-market devices. Indeed, in his video on the YOUTUBE website, Mr. Lee solicits video game developers to provide video games that are compatible with the head-tracking capabilities of the Wii Remote.

But this type of solution is costly and slow. And, even if this type of solution is implemented, end-user application developers may choose to modify and re-release only a small subset of end-user applications. As a result, the potential benefits of after-market devices would be lost on a large segment of end-user applications.

Given the foregoing, what is needed are methods, systems, and computer program products for integrating external input data into an application.

### BRIEF SUMMARY OF THE INVENTION

The present invention meets the above-described needs by providing methods, systems, and computer-program products for integrating external input into an application. In embodiments, the external input from an after-market device is integrated into an application with little or no modifications to the application.

For example, an embodiment of the present invention provides a method for integrating external input into an application. First, a camera view of the application and an input from an after-market device are received. Second, an adjusted camera view is generated based on the camera view of the application and the input from the after-market device. Then, the adjusted camera view is provided to a display device.

Another embodiment of the present invention provides a computer-program product including a computer-readable storage medium having control logic stored therein for causing a computer to integrate external input into an application. The control logic includes first, second, and third computer-readable program code. The first computer-readable program code causes the computer to receive a camera view of the application and an input from an after-market device. The second computer-readable program code causes the computer to generate an adjusted camera view based on the camera view of the application and the input from the after-market device. The third computer-readable program code causes the computer to provide the adjusted camera view to a display device.

A further embodiment of the present invention provides a system for integrating external input into an application. The system includes a graphics processing unit (GPU) and an interface module. The GPU is configured to execute graphics processing tasks for the application. The interface module is configured to (i) receive a camera view of the application and an input from an after-market device and (ii) generate an adjusted camera view based on the camera view of the application and the input from the after-market device. The adjusted camera view is then provided to a display device.

Further features and advantages of the invention, as well as the structure and operation of various embodiments of the invention, are described in detail below with reference to the accompanying drawings.

### BRIEF DESCRIPTION OF THE DRAWINGS/FIGURES

The accompanying drawings, which are incorporated herein and form part of the specification, illustrate the present invention and, together with the description, further serve to explain the principles of the invention and to enable a person skilled in the relevant art(s) to make and use the invention.

FIG. 1 depicts an example interface module for adjusting a camera view of an application based on an input from an after-market device.

FIG. 2 depicts an example computer system in which embodiments of the present invention may be implemented.

FIG. 3 illustrates an embodiment in which the interface module of FIG. 1 comprises a special library that adjusts a camera view of an application based on input from the after-market device.

FIG. 4 illustrates an embodiment in which the interface module of FIG. 1 comprises an intercepting library that intercepts standard commands intended for an API and adjusted the camera view of the application based on input from the after-market device.

FIG. 5 illustrates an embodiment in which the interface module of FIG. 1 comprises a modified library included in an API, wherein the modified library is configured to adjust the camera view of the application based on input from the after-market device.

FIG. 6 illustrates an embodiment in which the interface module of FIG. 1 is included within the driver of a graphics hardware device.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE INVENTION

### I. Overview

The present invention is directed to integrating external input into an application, and applications thereof. In this document, references to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

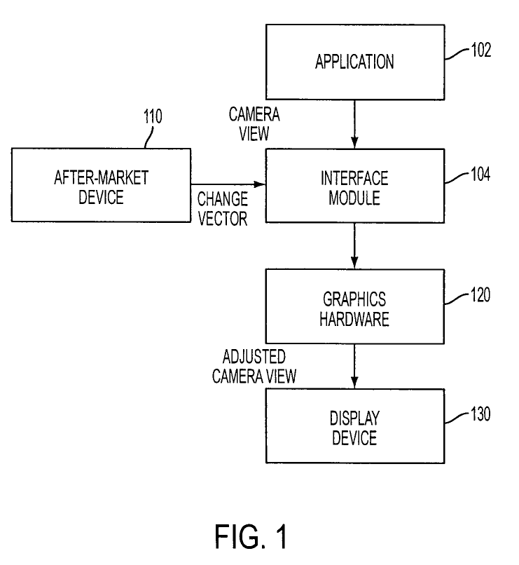

In accordance with an embodiment of the present invention, an interface module provides an adjusted camera view to a display device based on input from an after-market device and a camera view from an application. For example, FIG. 1 depicts a block diagram illustrating an example interface module 104 configured to receive input from an after-market device 110 and use it to transparently adjust the camera view of an application 102 with minimal or no modification to application 102. The adjusted camera view may include, but is not limited to, a camera rotation, a camera displacement, a rotation relative to view center, a displacement relative to view center, a combination thereof, or some other camera adjustment as would be apparent to a person skilled in the relevant art(s). Interface module 104 relies on graphics processing tasks performed by graphics hardware 120 (such as a GPU) in order to provide the adjusted camera view to a display device 130.

The input from after-market device 110 may comprise a three-dimensional vector (e.g., an X-Y-Z vector), also called a change vector, against a given scale (e.g., [Xmin, Ymin, Zmin—Xmax, Ymax, Zmax]). Interface module 104 may receive the input from several different types of after-market devices—such as, for example, a commercial head-tracking system, a Nintendo Wii Remote (as modified, for example, in the manner described by Johnny Chung Lee), a keyboard, a mouse, a digital dial, a camera tracking an object, a light sensor, a range finder, or some other type of device for receiving input from a user or external environment. Accordingly, as used herein, an “after-market device” refers to a device that is configured to receive input from a user or surrounding environment in order to adjust a camera view of an application, wherein the application is not originally designed to adjust the camera view based on the input from that device.

In embodiments, interface module 104 is implemented as (i) a special library to which applications link, (ii) an intercepting library that intercepts calls to an API, (iii) a modified library couched within an API, or (iv) a module within a graphics driver.

Although embodiment (i) requires a relatively simple change to the application to use the special library, embodiments (ii)-(iv) require no change to current applications in order to receive input from an after-market device. For example, interface module 104 (which may include or receive a configuration file) can act as a mechanism to “tweak” the inputs into the system to scale to each application, but interface module 104 is independent of the application and as such does not require recompilation/re-distribution of the application. Because applications do not have to be modified to receive input from an after-market device for embodiments (ii)-(iv), embodiments of the present invention can provide users with a new sense of immersion and interaction from applications (such as video games) that were not originally developed to provide such immersive and interactive experiences.

Before providing details regarding such embodiments, however, it is first helpful to present an example system in which such embodiments may be implemented.

### II. An Example System

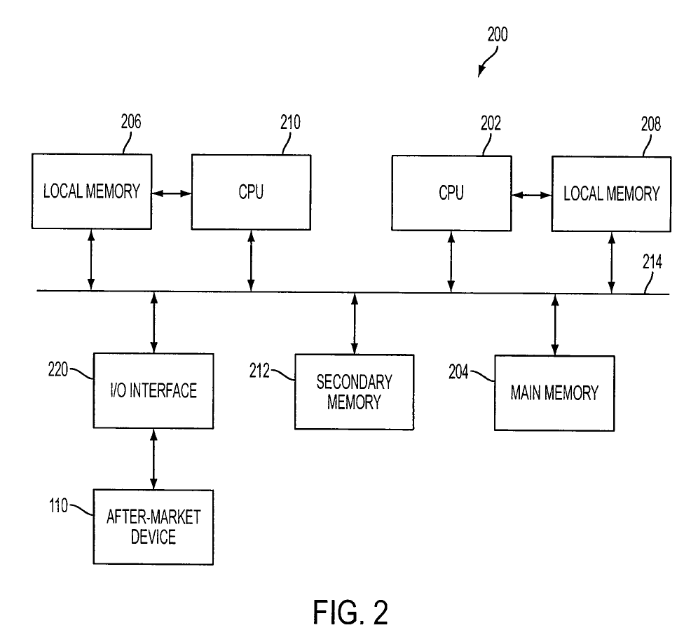

FIG. 2 depicts a block diagram illustrating an example computing system 200 that integrates external input from after-market device 110 into an application in accordance with an embodiment. Computing system 200 includes a central processing unit (CPU) 202, a graphics processing unit (GPU) 210, local memories 206 and 208, main memory 204, secondary memory 212, and an input/output (I/O) interface 220, which are each coupled to a bus 214. Bus 214 may be any type of bus used in computer systems, including a peripheral component interface (PCI) bus, an accelerated graphics port (AGP) bus, and a PCI Express (PCIE) bus.

GPU 210 assists CPU 202 by performing certain special functions, usually faster than CPU 202 could perform them in software. In alternative embodiments, GPU 210 may be integrated into a chipset and/or CPU 202. In an embodiment, GPU 210 decodes instructions in parallel with CPU 202 and execute only those instructions intended for it. In another embodiment, CPU 202 sends instructions intended for GPU 210 to a command buffer.

Local memories 206 and 208 are available to GPU 210 and CPU 202, respectively, in order to provide faster access to certain data (such as data that is frequently used) than would be possible if the data were stored in main memory 204 or secondary memory 212. Local memory 206 is coupled to GPU 210 and also coupled to bus 214. Local memory 208 is coupled to CPU 208 and also coupled to bus 214.

Main memory 204 is preferably random access memory (RAM). Secondary memory 212 may include, for example, a hard disk drive and/or a removable storage drive (such as, for example, a floppy disk drive, a magnetic tape drive, an optical disk drive). As will be appreciated, the removable storage unit includes a computer-readable storage medium having stored therein computer software and/or data. Secondary memory 212 may include other devices for allowing computer programs or other instructions to be loaded into computer system 200. Such devices may include, for example, a removable storage unit and an interface. Examples of such may include a program cartridge (such as, for example, a video game cartridge) and cartridge interface, a removable memory chip (such as an erasable programmable read only memory (EPROM), or programmable read only memory (PROM)) and associated socket.

I/O interface 220 is configured to couple after-market device 110 to bus 214. In embodiments, I/O interface 220 may be configured to receive input from after-market device 110 and convert the input into a format that can be placed on bus 214 so that other components of system 200 can access the input. Similarly, I/O interface 220 may also be configured to receive output placed on bus 214 and convert the output into a format that can be received by after-market device 110. Depending on the particular implementation of after-market device 110, I/O interface 220 may comprise hardware, software, or a combination thereof.

### III. Example Embodiments of Interface Module 104

As mentioned above, interface module 104 integrates external input from an after-market device into an application to adjust the camera view of the application. As described in more detail below, interface module 104 may be implemented as (A) a special library to which applications link, (B) an intercepting library that intercepts camera-related calls to an API, (C) a modified library couched with an API, or (D) a module within a graphics driver. It is to be appreciated, however, that these implementations are presented for illustrative purposes only, and not limitation. Other implementations of interface module 104 may be realized without deviating from the spirit and scope of the present invention.

A. Special Library

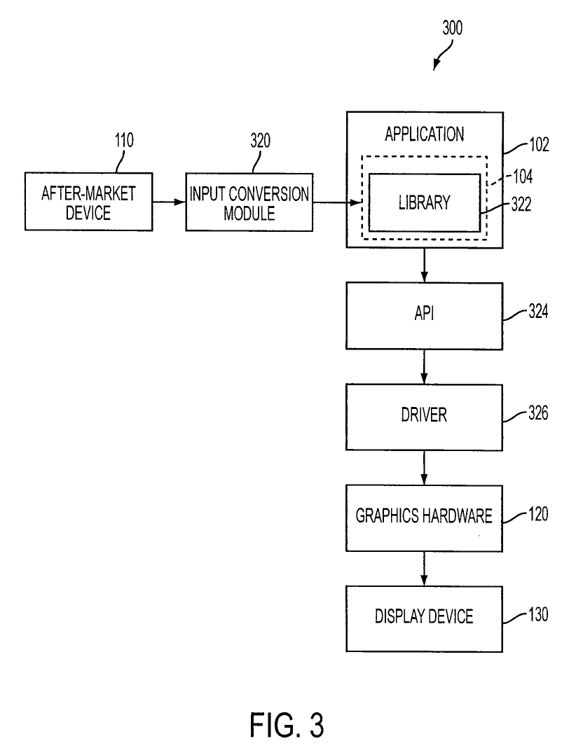

FIG. 3 depicts a block diagram 300 in which interface module 104 is implemented as a specially created library 322 in accordance with an embodiment of the present invention. In this embodiment, an application designer modifies application 102 to link to library 322. Library 322 arbitrates changes to the camera view of application 102.

Application 102 is an end-user application that requires graphics processing capability (such as, for example, a video game application, a web browser, a CAD application, a CAM application, or the like). Application 102 makes calls to library 322 regarding the camera view and sends all other graphics processing commands to API 324.

Library 322 is a specially created library that is configured to adjust the camera view of application 102. Library receives the current camera setup from application 102 and external data from after-market device 110 via input conversion module 320. Input conversion module 320 may comprise hardware (such as, for example, I/O interface 110), software, or a combination thereof for providing the external input from after-market device 110 to library 322. For commands regarding the camera view, application 102 makes a call to library 322 before the initial camera setup. The input to library 322 is the current camera setup (position and direction vectors), and the output from library 322 is the new camera position and direction vector.

For example, if library 322 is offered under Microsoft XNA from Microsoft Corp., then the following piece of code from Microsoft XNA:

device.Transform.View = Matrix.LookAtLH(new Vector3(0,0,−30), new
Vector3(0,0,0), new Vector3(0,1,0));

can be modified to call library 322 and then call the LookAtLH function, as follows:

AMDLibrary.CameraView look = AMDLibrary.RotateCamera(new
Vector3(0,0,−30), new Vector3(0,0,0), new Vector3(0,1,0));
device.Transform.View = Matrix.LookAtLH(look.position,
look.target, look.upvector);

In this example, because the Matrix.LookAtLH function is used in XNA for Windows PCs and Windows Mobile to construct the view, and because Open GL can use similar camera data provided by library 322 to construct the view, a call to library 322 may be used in a plurality of applications in a mostly platform agnostic way. If no input from after-market device 110 is received by library 322, application 102 continues to act as normal based on communications with API 324.

API 324 is an intermediary between application software, such as application 102, and graphics hardware 120 on which the application software runs. With new chipsets and entirely new hardware technologies appearing at an increasing rate, it is difficult for application developers to take into account, and take advantage of, the latest hardware features. It is also increasingly difficult for application developers to write applications specifically for each foreseeable set of hardware. API 324 prevents application 102 from having to be too hardware specific. Application 102 can output graphics data and commands to API 324 in a standardized format, rather than directly to graphics hardware 120. API 324 may comprise a commercially available API (such as, for example, DirectX® developed by Microsoft Corp. of Mountain View, Calif. or OpenGL® developed by Silicon Graphics, Inc. of Sunnyvale, Calif.), a custom API, or the like. API 324 communicates with driver 326.

Driver 326 is typically written by the manufacturer of graphics hardware 120, and translates standard code received from API 324 into native format understood by graphics hardware 120. Driver 326 communicates with graphics hardware 120.

Graphics hardware 120 may comprise graphics chips (such as GPU 210) that each include a shader and other associated hardware for performing graphics processing. When rendered frame data processed by graphics hardware 120 is ready for display it is sent to display device 130. Display device 130 comprises a typical display for visualizing frame data as would be apparent to a person skilled in the relevant art(s).

Thus, the embodiment depicted in FIG. 3 enables the camera view of application 102 to be adjusted based on external input from after-market device 110 by using library 322 included in application 102.

B. Intercepting Library

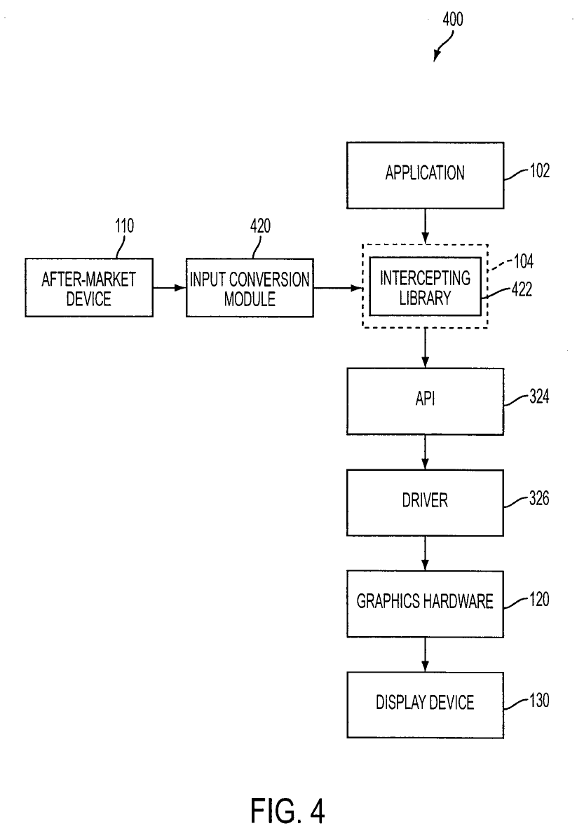

FIG. 4 depicts a block diagram 400 in which interface module 104 is implemented as an intercepting library 422 in accordance with an embodiment of the present invention. In this embodiment, intercepting library 422 intercepts camera-related calls from application 102 to API 324 and redirects the camera-related calls to a special wrapper function of intercepting library 422. The special wrapper function augments the camera-related calls and allows the camera view to be modified before the modified camera view is sent to API 324.

In addition to intercepting camera-related calls from application 102, intercepting library 422 receives external data from after-market device 110 via input conversion module 420. Input conversion module 420, like input conversion module 320 described above, may comprise hardware (such as, for example, I/O interface 110), software, or a combination thereof for providing the external input from after-market device 110 to intercepting library 422.

API 324 receives the modified camera view from intercepting library 422 and translates the modified camera view into a standard format set of commands and/or data as set forth above. API 324 then sends the standard format commands and/or data to driver 326.

Driver 326, graphics hardware 120, and display device 130 function in a similar manner to that described above with respect to FIG. 3, and are therefore not described again for the sake of brevity.

Thus, the embodiment depicted in FIG. 4 enables the camera view of application 102 to be adjusted based on input from after-market device 110 by using intercepting library 422. Because application 102 does not have to be modified to receive input from after-market device 110, intercepting library 422 can provide users with a new sense of immersion and interaction from application 102, even if application 102 was not originally developed to provide such immersive and interactive experiences.

C. Modified Library

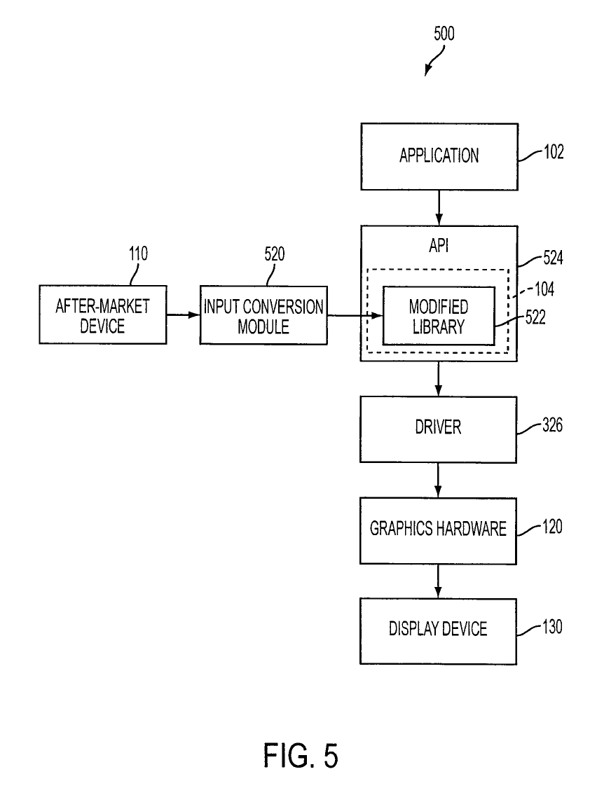

FIG. 5 depicts a block diagram 500 in which interface module 104 is implemented as a modified library 522 included in API 524 used by application 102. In addition to receiving camera-related calls from application 102, modified library 522 receives external data from after-market device 110 via input conversion module 520. Input conversion module 520, like input conversion modules 320 and 420 described above, may comprise hardware (such as, for example, I/O interface 110), software, or a combination thereof for providing the external input from after-market device 110 to modified library 522. One or more functions included in a standard API can be modified to use a file as input, wherein the file includes the external data from after-market device 110. Accordingly, modified library 522 can be used for adjusting the camera view of application 102, without modifying application 102.

For example, the setViewMatrixAsLookAt function from SDL (Simple Directmedia Layer) can be modified to use a file as input. Similarly, the gluLookAt function of the libGLU library can be modified to use a file or communication from a device as an input for altering the camera position along an hemispherical surface centered on the glDouble Center triplet position. The file or communication may be passed into the function to produce a different visual. Also, the modified function may optionally ensure that the up vector is changed to look towards the requested center.

Based on the output from modified library 522, API 524 sends standard format data and commands to driver 326. Driver 326, graphics hardware 120, and display device 130 function in a similar manner to that described above with respect to FIGS. 3 and 4, and are therefore not described again for the sake of brevity.

Thus, the embodiment depicted in FIG. 5 enables the camera view of application 102 to be adjusted based on input from after-market device 110 by using modified library 522. Because application 102 does not have to be modified to receive input from after-market device 110, modified library 522 can provide users with a new sense of immersion and interaction from application 102, even if application 102 was not originally developed to provide such immersive and interactive experiences.

D. Modified Driver

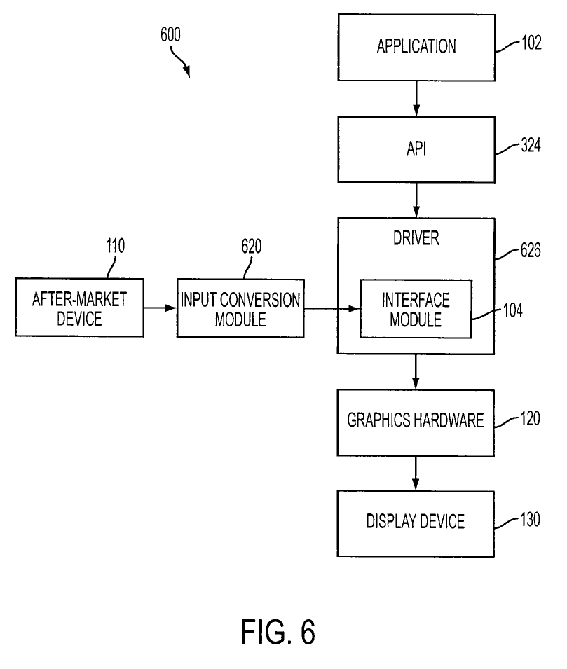

FIG. 6 depicts a block diagram 600 in which interface module 104 is included in a graphics driver 626 in accordance with an embodiment of the present invention. In this embodiment, application 102 sends standard format commands to API 324 as set forth above. API 324 communicates these commands to driver 626.

Camera-related calls to driver 626 are identified and corresponding return values are augmented based on external input from after-market device 110 to provide an adjusted camera view to graphics hardware 120. In addition to receiving camera-related calls from application 102, interface module 104 of driver 626 receives external data from after-market device 110 via input conversion module 620. Input conversion module 620—like input conversion modules 320, 420, and 520 described above—may comprise hardware (such as, for example, I/O interface 110), software, or a combination thereof for providing the external input from after-market device 110 to interface module 104. Although this method may not reliably work for all instantiations of application 102, this method requires no modifications to application 102. Driver 626 provides the adjusted camera view to graphics hardware 120.

Graphics hardware 120 and display device 130 function in a similar manner to that described above with respect to FIGS. 3-5, and are therefore not described again for the sake of brevity.

Thus, the embodiment depicted in FIG. 6 enables the camera view of application 102 to be adjusted based on input from after-market device 110 by using interface module 104 of driver 626. Although driver 626 may not reliably identify all camera-related calls from application 102, this embodiment requires no modifications to application 102. Accordingly, interface module 104 of driver 626 can provide users with a new sense of immersion and interaction from application 102, even if application 102 was not originally developed to provide such immersive and interactive experiences.

### IV. Example After-Market Devices

As mentioned above, after-market device 110 is a device that is configured to receive input from a user or surrounding environment in order to adjust a camera view of application 102, even when application 102 is not originally designed to adjust the camera view based on the input from that device. Provided below are examples of after-market device 110, and descriptions regarding how each example may be used to provide a user with a more immersive and interactive experience. It is to be appreciated, however, that these examples are presented for illustrative purposes only, and not limitation. Other types of after-market devices may be used in accordance with embodiments of the present invention as would be apparent to persons skilled in the relevant art(s).

A. Light Sensor

In an embodiment, after-market device 110 is embodied as a light sensor that identifies the light level of an external environment (e.g., an environment in which a user is situated). The light sensor may be used, for example, in a video-player application to adjust the light level of the video-player application to provide a consistent viewing experience in all light levels of the external environment. The light sensor can be used with any of the embodiments described above with respect to FIGS. 3-6.

B. Head-Tracking

In an embodiment, after-market device 110 is embodied as a head-tracking device (such as, for example, a Wii remote configured for head tracking). The head-tracking device may be used, for example, in a first-person shooter game to match the game-character view with the real-world viewing angle of the user playing the first-person shooter game. The head-tracking device can be used with any of the embodiments described above with respect to FIGS. 3-6.

C. Tilt-Sensor

In an embodiment, after-market device 110 is embodied as a tilt sensor. The tilt sensor may be used, for example, in a global-viewing application (such as, for example, GOOGLE EARTH provided by Google Inc. of Mountain View, Calif.) to adjust the angle of the view in the global-viewing application based on the angle of the tilt sensor with respect to a reference plane (e.g., a horizontal plane). The tilt sensor can be used with any of the embodiments described above with respect to FIGS. 3-6.

D. Ranger Finder

In an embodiment, after-market device 110 is embodied as a range finder (e.g., distance sensor). The range finder may be used, for example, in a 3D virtualization application. In this example, as the user moves further from a display device, the level of visible detail is configured to decrease (inverse tessellation), whereas conventional level of detail metrics are based on the position of a 3D camera and do not change as the user gets closer to or further from the display device. The range finder can be used with any of the embodiments described above with respect to FIGS. 3-6.

V. Example Software Implementations

In addition to hardware implementations of GPU 210, such GPUs may also be embodied in software disposed, for example, in a computer-readable medium configured to store the software (e.g., a computer-readable program code). The program code causes the enablement of embodiments of the present invention, including the following embodiments: (i) the functions of the systems and techniques disclosed herein (such as adjusting a camera view of an application based on external input from an after-market device as depicted, for example, in FIGS. 1 and 3-6); (ii) the fabrication of the systems and techniques disclosed herein (such as the fabrication of GPU 210); or (iii) a combination of the functions and fabrication of the systems and techniques disclosed herein.

The program code may be embodied in general programming languages (such as C or C++), hardware description languages (HDL) including Verilog HDL, VHDL, Altera HDL (AHDL) and so on, or other available programming and/or schematic capture tools (such as circuit capture tools). The program code can be disposed in any known computer-readable medium including semiconductor, magnetic disk, and optical disk (such as CD-ROM, DVD-ROM). As such, the code can be transmitted over communication networks including the Internet and internets. It is understood that the functions accomplished and/or structure provided by the systems and techniques described above can be represented in a core (such as a GPU core) that is embodied in program code and may be transformed to hardware as part of the production of integrated circuits.

### VI. Conclusion

Set forth above are example systems, methods, and computer-program products for integrating external input data into an application. While various embodiments of the present invention have been described above, it should be understood that they have been presented by way of example only, and not limitation. It will be apparent to persons skilled in the relevant art that various changes in form and detail can be made therein without departing from the spirit and scope of the invention.

For example, embodiments of the present invention extend to 2D and 3D applications. In addition, a 2D image can be converted into a 3D image and then controlled via embodiments of the present invention for rotating around the 3D image. If the 2D-to-3D conversion can be run in real time, a 3D TV can be created for the one user controlling an after-market input device.

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way. Thus, the breadth and scope of the present invention should not be limited by any of the above-described exemplary embodiments, but should be defined only in accordance with the following claims and their equivalents.

What is claimed is:

1. A method for integrating external input into an application, comprising:
(a) receiving a camera view of the application and an input from an after-market device;
(b) generating an adjusted camera view based on the camera view of the application and the input from the after-market device; and
(c) providing the adjusted camera view to a display device.

2. The method of claim 1, wherein (a) comprises:
(a1) providing a library to receive the camera view of the application and to receive the input from the after-market device, wherein the library is linked to by the application.

3. The method of claim 1, wherein (a) comprises:
(a1) providing a library to receive the camera view of the application and to receive the input from the after-market device, wherein the library intercepts camera-related commands from the application to an application programming interface.

4. The method of claim 1, wherein (a) comprises:
(a1) providing a library to receive the camera view of the application and to receive the input from the after-market device, wherein the library is included within an application programming interface.

5. The method of claim 1, wherein (a) comprises:
(a1) providing a driver to receive the camera view of the application and to receive the input from the after-market device.

6. The method of claim 1, wherein the after-market device comprises a light sensor that is configured to sense a light level of an external environment, and wherein (b) comprises:
adjusting a light level of the adjusted camera view based on the light level of the external environment as sensed by the light sensor.

7. The method of claim 1, wherein the after-market device comprises a head-tracking device configured to track a position of a user's head, and wherein (b) comprises:
adjusting a view perspective of the adjusted camera view based on the position of the user's head as tracked by the head-tracking device.

8. The method of claim 1, wherein the after-market device comprises a tilt sensor configured to sense a tilt of the tilt sensor with respect to a reference plane, and wherein (b) comprises:
adjusting a perspective of the adjusted camera view based on the tilt as sensed by the tilt sensor.

9. The method of claim 1, wherein the after-market device comprises a distance sensor configured to sense a distance between the tilt sensor and a reference point, and wherein (b) comprises:
adjusting a level of detail of the adjusted camera view based on the distance as sensed by the distance sensor.

10. A computer-program product comprising a computer-readable storage medium having control logic stored therein for causing a computer to integrate external input into an application, the control logic comprising:
first computer-readable program code for causing the computer to receive a camera view of the application and an input from an after-market device;
second computer-readable program code for causing the computer to generate an adjusted camera view based on the camera view of the application and the input from the after-market device; and
third computer-readable program code for causing the computer to provide the adjusted camera view to a display device.

11. The computer-program product of claim 10, wherein the after-market device comprises a light sensor that is configured to sense a light level of an external environment, and wherein the second computer-readable program code comprises:
code for causing the computer to adjust a light level of the adjusted camera view based on the light level of the external environment as sensed by the light sensor.

12. The computer-program product of claim 10, wherein the after-market device comprises a head-tracking device configured to track a position of a user's head, and wherein the second computer-readable program code comprises:
code for causing the computer to adjust a view perspective of the adjusted camera view based on the position of the user's head as tracked by the head-tracking device.

13. The computer-program product of claim 10, wherein the after-market device comprises a tilt sensor configured to sense a tilt of the tilt sensor with respect to a reference plane, and wherein the second computer-readable program code comprises:
code for causing the computer to adjust a perspective of the adjusted camera view based on the tilt as sensed by the tilt sensor.

14. The computer-program product of claim 10, wherein the after-market device comprises a distance sensor configured to sense a distance between the distance sensor and a reference point, and wherein the second computer-readable program code comprises:
code for causing the computer to adjust a level of detail of the adjusted camera view based on the distance as sensed by the distance sensor.

15. A system for integrating external input into an application, comprising:
a graphics processing unit (GPU) configured to execute graphics processing tasks for the application; and
an interface module configured to (i) receive a camera view of the application and an input from an after-market device and (ii) generate an adjusted camera view based on the camera view of the application and the input from the after-market device.

16. The system of claim 15, wherein the interface module comprises a library to which the application links.

17. The system of claim 15, wherein the interface module comprises a library that is configured to intercept camera-related commands from the application to an application programming interface.

18. The system of claim 15, wherein the interface module comprises a library included within an application programming interface.

19. The system of claim 15, wherein the interface module is included within a driver.

20. The system of claim 15, wherein the after-market device comprises a light sensor that is configured to sense a light level of an external environment.

21. The system of claim 15, wherein the after-market device comprises a head-tracking device configured to track a position of a user's head.

22. The system of claim 15, wherein the after-market device comprises a tilt sensor configured to sense a tilt of the tilt sensor with respect to a reference plane.

23. The system of claim 15, wherein the after-market device comprises a distance sensor configured to sense a distance between the tilt sensor and a reference point.
